(19) United States
(12) Patent Application Publication
(10) Pub. No.: US 2004/0212674 A1
(43) Pub. Date: Oct. 28, 2004

(54) Fashion photography system for clothing stores

(76) Inventor: Ryan W. Massey, Clarkston, MI (US)

Correspondence Address: Ryan W. Massey, 6862 Hubbard Circle, Clarkston, MI, 48348, US

(21) Appl. No.: 10/272,338

(22) Filed: Oct. 16, 2002

(51) Int. Cl. H04N 7/18; G09G 5/00; G06T 15/00; G09B 25/00

(52) U.S. Cl. 348/77; 345/630; 345/419; 434/371

(57) ABSTRACT

A fashion photography system is provided in close proximity to a clothing store fitting room to allow a customer to try on outfits and/or articles and then to take photographs of themselves in the selected articles. The photographs are stored in a computer system to be reviewed by the customer for selecting from the articles that they tried on.

### FIELD OF THE INVENTION

The present invention relates to fashion shopping and more particularly, to a fashion photography system for use in a clothing store or shop to allow a user to take photographic images of clothing articles that they try on.

### BACKGROUND OF THE INVENTION

Clothing shopping can be relaxing and enjoyable to some people, while to other people it may be frustrating. One of the sources of frustration may involve a person finding several outfits to try on, and after several outfits have been tried on a user may eliminate some of the outfits or articles from their potential buy list, but may forget or be indecisive with regard to the remaining articles or outfits. In some instances, this leads to the shopper retrying on articles and outfits that have been previously tried on in order to refresh his or her memory as to how the article looked and/or fit. All of this trying on and re-trying on of outfits and articles can be time consuming and frustrating. Accordingly, it is desirable to provide a system that will allow a user to try on articles one time and then have a mechanism by which they can refresh their memory as to what the outfit looked like and how it fit.

In addition, after an outfit has been selected, it is sometimes necessary to find matching shoes and/or accessories such as jewelry, scarves, sweaters, jackets, and hosiery. Accordingly, it is desirable to provide a system that allows a user to view accessories that would complement the user's selected items.

### SUMMARY OF THE INVENTION

The present invention provides a fashion photography system that is utilized in close proximity to a fashion store fitting room to allow a customer to try on outfits and/or articles and then to take photographs of the customer in the selected articles. The photographs can be stored in a computer system to be reviewed by the shopper to refresh the shopper's memory of how the articles looked and/or fit on the shopper themselves. The fashion photography system allows a user to access his or her own photos, allows the user to view accessories that coordinate with the selected items that the shopper has tried on, provides pricing for the articles tried on, and provides estimates for indicated alterations that the shopper might desire.

The fashion photography system of the present invention eliminates some of the frustration and time associated with shopping for and trying on different outfits and matching associated accessories. The system of the present invention will help fashion stores and suit and dress shops to sell their clothing articles and accessories since the fashion photography system eliminates frustration and time for the shoppers and is, therefore, a selling point for the fashion stores.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of a fashion photography system according to the principles of the present invention;

FIG. 2 is a schematic view of a computer processor system and user interface for use with the fashion photography system according to the principles of the present invention;

FIG. 3 is an exemplary view of a user interface screen for registering a user of the fashion photography system of the present invention;

FIG. 4 is a user interface screen for allowing a user to enter an identification code for registration in the fashion photography system of the present invention;

FIG. 5 is a user interface menu screen according to the principles of the present invention;

FIG. 6 is a user interface screen for allowing a user to resume a paused photo shoot according to the principles of the present invention;

FIG. 7 is a user interface screen providing instructions for the user to take a photograph or photographs of the user wearing selected items according to the principles of the present invention;

FIG. 8 is a user interface menu screen to be used by the user according to the principles of the present invention;

FIG. 9 is a photo display screen which offers the option of providing ideas for accessories according to the principles of the present invention;

FIG. 10 is a user interface screen providing instructions to the user for scanning the bar codes on the clothing items according to the principles of the present invention;

FIG. 11 is a user interface screen for displaying the user's photographs in combination with suggested accessories according to the principles of the present invention;

FIG. 12 is a user interface screen for allowing the user to purchase items tried on and associated accessories; and

FIG. 13 is a user interface screen for allowing the user to scroll through various suggested accessories.

### DETAILED DESCRIPTION OF THE PREFERRED EMBODIMENTS

The following description of the preferred embodiment(s) is merely exemplary in nature and is in no way intended to limit the invention, its application, or uses.

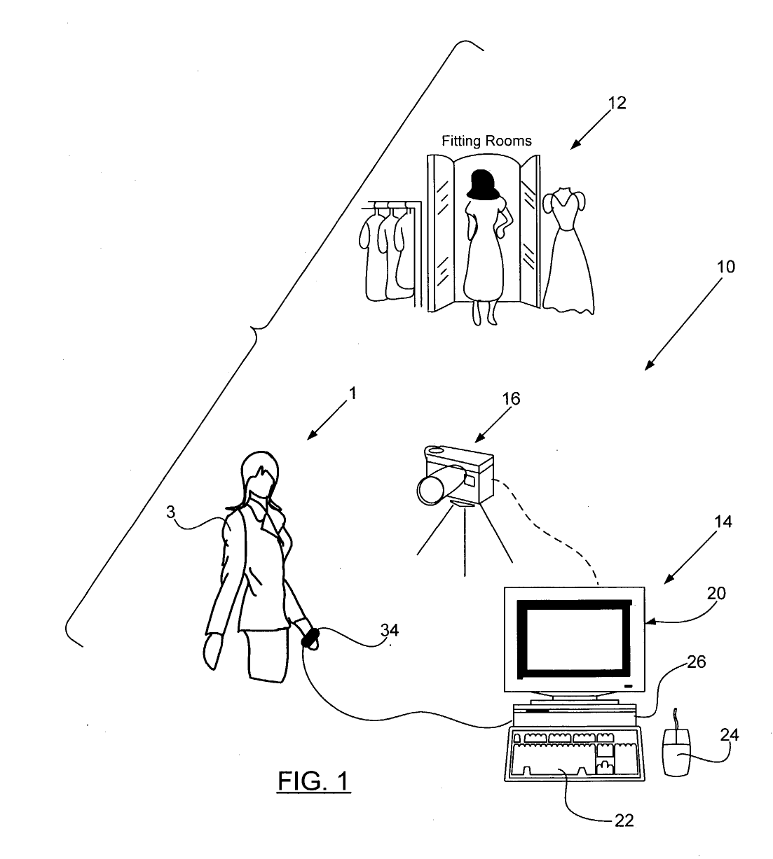

With reference to FIG. 1, a fashion photo system 10 is provided in proximity to a fitting room 12 of a fashion store or shop. The fashion photo system includes a user interface and the processor unit 14 as well as one or more (preferably at least two) cameras 16 which are preferably digital cameras for providing either still or moving pictures of the user. With the fashion photo system 10 of the present invention, a user 1 can try on different outfits or garments 3 and in close proximity to the fitting rooms 12 can use the user interface and processor unit 14 to store photo and/or video images of the user wearing the garments 3. The user can then try on additional outfits or garments and again store additional photo or video images of the user wearing these additional garments.

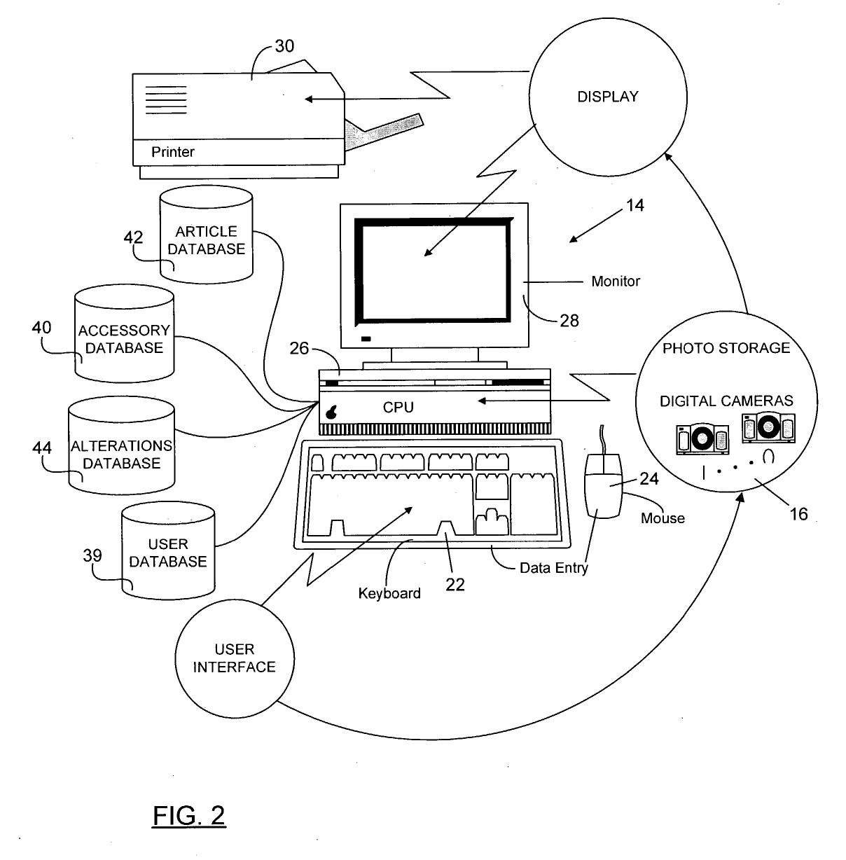

With reference to FIG. 2, the user interface and processor unit 14 is illustrated in greater detail. The user interface and processor unit 14 preferably includes a computer system 20 including a keyboard 22 and/or a mouse 24 that can be utilized for data entry by the user. A touch screen user interface could also be utilized. A central processor unit 26 is provided for storing digital images as well as including software for facilitating the user interface with the stored images via a display monitor 28 and printer 30. The digital cameras 16 are provided in communication with the central processor unit so that video and/or photographic images taken with the digital cameras can be stored to the central processor unit 26.

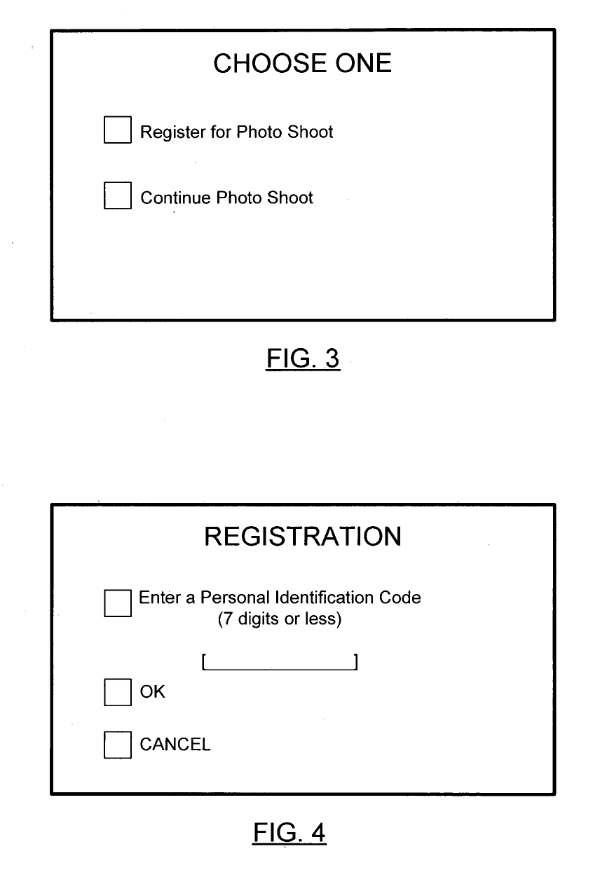

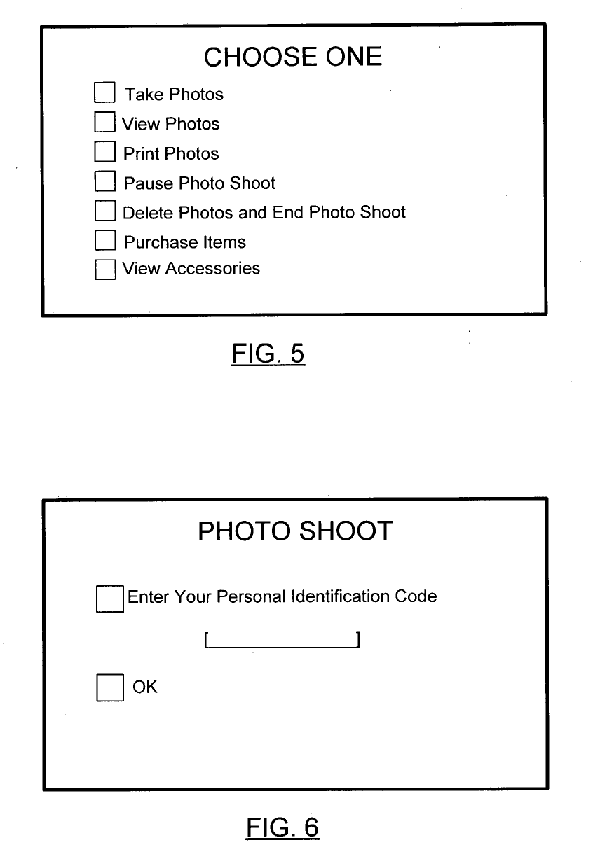

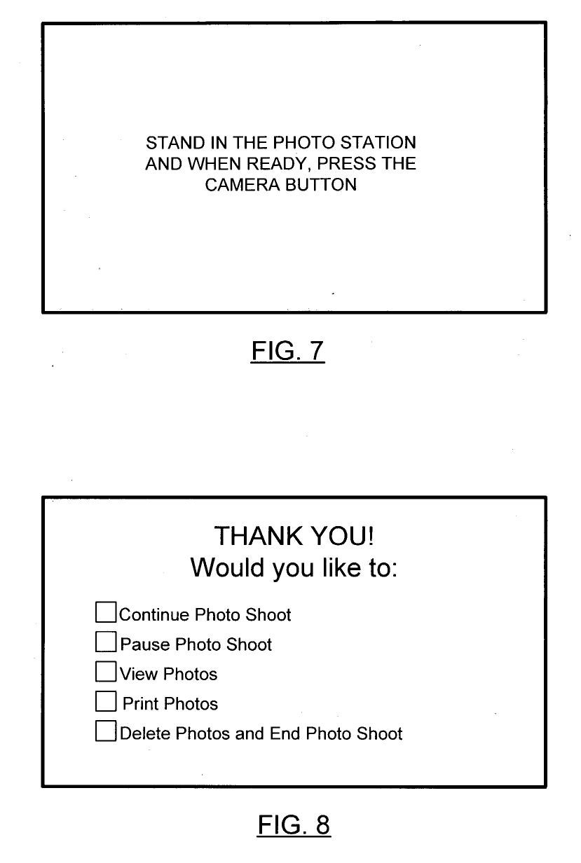

With reference to FIGS. 3-13, the user interface with the computer system 20 will now be described in greater detail. Initially, a shopper 1 who has chosen articles to be tried on will try on an article 3 in a fitting room 12, and then move to the fashion photography system 10 located in close proximity to the fitting rooms 12. The computer 20 will be provided with a user interface screen such as shown in FIG. 3 which allows a user to register for a photo shoot if registration has not already been previously completed, or to continue a photo shoot if registration has already been completed. If a user chooses the registration selection, a user interface screen such as illustrated in FIG. 4, will allow the user to register by entering a personal identification code selected by the user. The registration process provides an identifier for user photo images stored in a user database 39. Once registration is completed, a menu screen such as illustrated in FIG. 5 will be provided on the user interface screen to allow a user to select from different choices such as: Take Photos, View Photos, Print Photos, Pause Photo Shoot, Delete Photos, End Photo Shoot, and Purchase Items. If the user chooses to take photos, the user interface screen will provide instructions to the user such as shown in FIG. 7 to “stand in the photo station and when ready, press the camera button.” The camera button 34 can be located on the floor to be stepped on by the user to snap photos or can be a hand held button, voice activated or timed system. After photos have been taken, an additional menu screen, such as illustrated in FIG. 8, will be provided to allow the user to continue the photo shoot, pause the photo shoot, view photos, print photos, or delete and end the photo shoot. If the user, in response to screen 5 or 8, chooses to pause the photo shoot, the processor will temporarily bump the user out of the system so that the user can change into a different outfit.

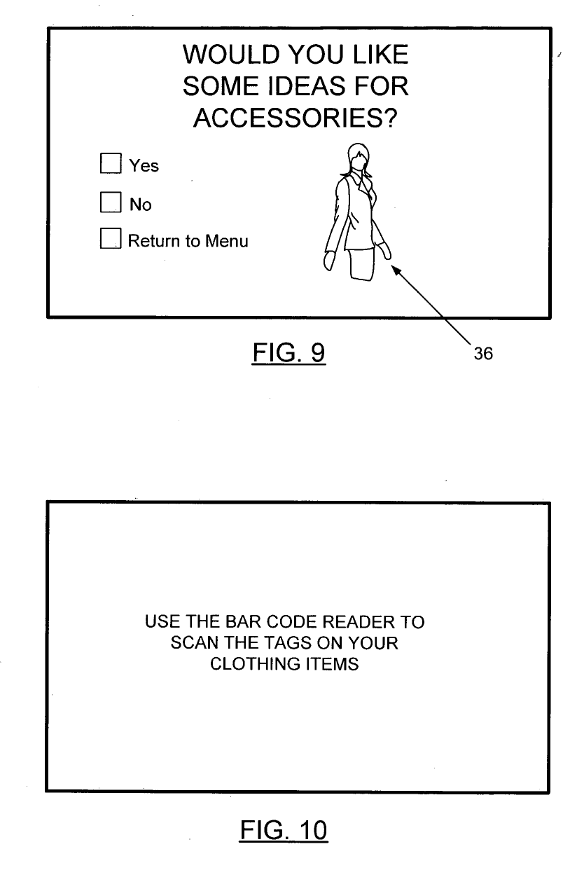

After the user has used the fitting rooms 12 to change outfits 3, and returns to the photo station 10, the computer 20 will again provide the user with the user interface screen illustrated in FIG. 3 at which time the user will select the “continue photo shoot” option. The user is then provided with a user interface screen such as illustrated in FIG. 6 which allows the user to enter their personal identification code. Once the proper code is entered, the user is provided with a user interface screen, such as illustrated in FIG. 5, to allow the user to choose one of the selected options. If the user decides to view existing photos, a display screen, such as illustrated in FIG. 9, is provided that shows the stored image of the user, as well as scroll buttons 36 that allow the user to scroll through different photos.

The display screen also asks the user if they would like some ideas for accessories. If the user selects “yes” in response to the inquiry, the user is asked to use a bar bode reader or other means for reading information regarding the article to scan the tags for identifying the clothing to be accessorized as illustrated in FIG. 10. Once the clothing items have been scanned and/or otherwise identified, the central processor unit searches its accessory database 40 to retrieve selected items which have been predetermined to be appropriate accessories for the selected outfits and/or garments. As illustrated in FIG. 11, photos and/or other information(such as in- stock availability, price and in-store location) regarding the suggested accessory items are then illustrated or otherwise listed on a user interface screen. The suggested accessories may include such items as jewelry, shoes, scarves, neckties, belts, sweaters, jackets, and hosiery. Information regarding the suggested accessory items and the scanned clothing articles are stored in the user database 39 in association with the user registration identification and a photo session number.

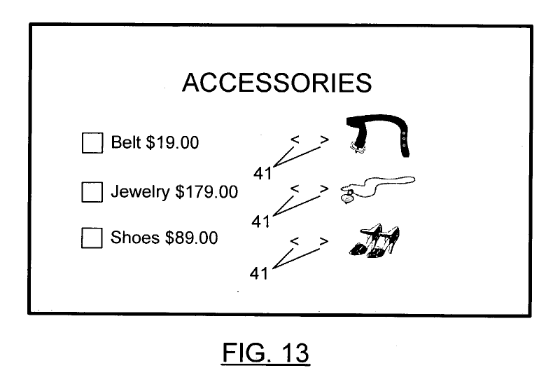

The accessory suggestion feature can also be utilized separate from the fashion photography system. By choosing the accessory option of FIG. 5, a user, such as a customer or store clerk, can scan or otherwise read information from a clothing article or articles to be accessorized, and the central processor unit 26 can access the accessory database 40 to find and display photo images and/or other information relating to associated accessories for the articles that were scanned. The accessory suggestion feature includes a user interface screen such as illustrated in FIG. 13 which allows the user to choose from and scroll through (using scroll buttons 41) different types of accessory options such as belts, shoes, jewelry, hosiery, neckware, jackets, sweaters, etc.

As an additional option, price information can be retrieved from an article database 42 and can be provided with regard to the scanned clothing articles and suggested accessories. A total price may also be provided based upon this information as calculated by the central processor unit 26. Additional functions of the system of the present invention include offering the user information regarding possible alterations. The user can be prompted to enter the types of alterations needed, such as cuffs, waistband, etc., and a standard alterations price database 44 is accessed by the central processor unit to provide the user with the estimated cost for alterations, and the total cost is provided at the bottom of the screen as shown in FIG. 11.

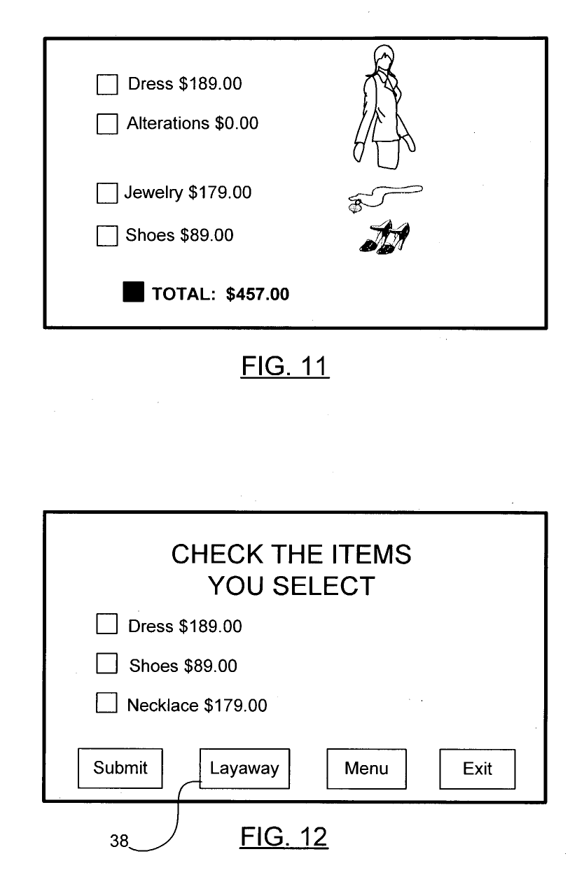

As an additional option, the user interface system is used as a cashier station to allow the user to select and purchase the items using the user interface system. Computerized cash register systems such as this, are well known in the art. This system allows the customer to be more efficiently checked out since the items would not need to be re-scanned by a cashier. A user interface screen, such as illustrated in FIG. 12, lists all the items that have been scanned and tried on by the user in addition to any potential accessories that have been suggested to the user. The user can then check off any item that they wish to purchase and/or delete any items that they do not wish to purchase using the computer interface system 14.

As an additional option, the user is provided with a “print photos” option (FIGS. 5 and 8) to allow the user to have copies of the photographs of the outfits that they tried on so that they can comparison shop with other outfits they find at other stores. As yet another feature, the user interface menu (FIGS. 5 and 8) allows the user to delete photographs that have been stored in the system and can optionally provide a temporary data storage to allow the user to store, for a limited period of time, information regarding items that were tried on, and accessories that were suggested. Thus, a user can return to the store within a predetermined period of time without having to spend unnecessary time tracking down previously tried-on clothing items. In addition, information regarding layaway items (such as the user's name) can also be stored in association with the user's identification code by pressing the lawaway key 38 in FIG. 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fashion photography system for clothing stores, comprising:
at least one dressing room; and
at least one photography station in proximity to said at least one dressing room and including at least one camera connected to a central processor unit for storing and accessing photo images taken by said camera, and a user interface and monitor for allowing a user to access and view photos taken by said camera.

2. The fashion photography system of claim 1, wherein said user interface and central processing unit provide a user registration for establishing a database user identification for storing the user's photo images in association therewith.

3. The fashion photography system of claim 1, wherein said user interface provides a user with an option to pause a photo shoot.

4. The photography system of claim 1, wherein said user interface provides a user with an option to delete photos.

5. The fashion photography system of claim 1, wherein said user interface provides a user with an option to purchase items.

6. The fashion photography system of claim 1, wherein said user interface provides a user with an option to view accessories for an outfit.

7. The fashion photography system of claim 1, further comprising an accessory database including information regarding accessories that are predetermined to be appropriate accessories for selected articles of clothing, said central processor unit being capable of accessing said information regarding accessories from said accessory database for display to a user.

8. The fashion photography system of claim 7, wherein said information regarding accessories includes photo images of said accessories.

9. The fashion photography system of claim 1, further comprising an article database including price information regarding clothing articles, said central processor unit being capable of accessing said price information regarding clothing articles from said article database for display to a user.

10. The fashion photography system of claim 1, wherein said photography station includes a camera button actuatable by a user to take photo images using said at least one camera.

11. The fashion photography system of claim 1, further comprising an information reader device for reading information regarding the articles tried on by the user, said central processor unit storing said information regarding the articles in association with the user.

12. The fashion photography system of claim 10, further comprising an accessory database including information regarding accessories that are predetermined to be appropriate accessories for selected articles of clothing, said central processor unit accessing said information regarding accessories from said accessory database for display to a user.

13. A clothing accessory suggestion system, comprising:
a central processor unit;
an information reading device in communication with said central processor unit for reading information from a clothing article; and
an accessory database including information regarding clothing accessories that are predetermined to be appropriate accessories for selected articles of clothing, said central processor unit accessing said information regarding accessories from said accessory database for display to a user.

14. The system of claim 13, wherein said information regarding clothing accessories includes photo images of the clothing accessories.

15. The system of claim 13, wherein said information regarding clothing accessories includes information regarding in-stock availability.

16. The system of claim 13, wherein said information regarding clothing accessories includes the clothing accessory in-store location.
